(19) United States
(12) Patent Application Publication
(10) Pub. No.: US 2004/0216367 A1
(43) Pub. Date: Nov. 4, 2004

(54) Non-drying adhesive tapes and diatomaceous earth treated insect control devices

(76) Inventor: Arnold Gregory Klein, Sandia Park, NM (US)

Correspondence Address: Arnold G. Klein, PO Box 724, Sandia Park, NM, 87047, US

(21) Appl. No.: 10/802,329

(22) Filed: Mar. 16, 2004

Related U.S. Application Data
(60) Provisional application No. 60/456,410, filed on Mar. 24, 2003.

(51) Int. Cl. A01M 1/14

(52) U.S. Cl. 43/114

(57) ABSTRACT

The invention consists of a related series of simple device embodiments used for the spot control of insect pests. Each of the invention embodiments uses the relatively common, non-toxic insect control substances, including a non-drying adhesive and/or diatomaceous earth and stabilizes them for convenient, effective application by affixing them to a disposable media carrier, such as paper, vinyl, thin foam, cellophane, etc. The first embodiment of the invention has the form of a double sided tape with a standard contact adhesive on one side and a tacky, non-drying adhesive on the other side. The non-drying adhesive acts as an effective insect barrier when the tape is applied around a perimeter to restrict crawling insect passage. A refinement of the double sided tape invention embodiment has the outside facing non-drying adhesive applied in combination with an adjacent or interspersed pattern of applied diatomaceous earth. The combination of the tacky, non-drying adhesive and diatomaceous earth work together to effectively kill crawling insects. Another embodiment of the invention uses a diatomaceous earth impregnated media that is cellulose based and which may be baited with sugar or other insect attracting substance(s). This cellulose based media is made in the form of a decal applique or stand alone form that can be applied to a plant leaf or affixed to some other plant or garden structure. When insects eat the leaf where the decal is affixed or the stand alone form they ingest the diatomaceous earth which effectively kills them by shredding their gut.

### BACKGROUND OF THE INVENTION

At the present time, there are a multitude of commercial products, both applications and devices available for controlling, repelling and/or exterminating insects in the home, garden, commercial establishments, etc. The majority of these products use a chemically based insecticide or repellant. These chemically based insect controls, particularly the insecticides are very effective for the control of pest insects, but typically they have serious, undesirable side effects. These chemically based insect controls are often toxic or semi-toxic to non-targeted organisms including pets or other animals, birds, children, etc.

In recent years, consumers have become increasingly environmentally conscious and aware of the undesirable side effects of using chemically based insect control products. As a result of this increased environmental awareness, a growing need has emerged for convenient, non-toxic insect control products. Gardeners, especially “organic” gardening practitioners are more interested in non-toxic insect pest controls. There is increasing awareness that spot insect control and focused insect extermination are preferable to wide spectrum insecticide overkill.

There are many non-toxic means of controlling insect pests. Once of the most widely used means is by using an insect trap (i.e. Roach Hotel®) that uses an edible bait or pheromone attractant to lure insects into the trap interior that is coated with a non-drying adhesive. Once the pest insect comes into contact with the adhesive, they are held in place and die. Perhaps the oldest and most common insect control product is flypaper. Both of these non-drying adhesive insect controls can be very effective, but in use they are normally confined to very specific pest control applications like flypaper for fly control and insect (roach, etc.) traps. One widely used product for crawling insect control is a non-toxic, non-drying adhesive known by the trade name Tanglefoot®. This product is marketed as an insect barrier that can be spot applied. This product is very effective as an insect barrier, but as it is directly applied to surfaces, it is limited to outdoor applications where removal or cleaning is not required. Once applied, this non-drying adhesive is very difficult to completely remove.

Another mechanical (non-chemical) means of insect control is the surface application of a substance known as diatomaceous earth. Diatomaceous earth is a non-toxic, inert material, made up of the microscopic skeletons of minute, one celled plants, called diatoms that existed in vast numbers in the earth's seas approximately 300 million years ago. When diatomaceous earth is quarried, milled, finely ground, and screened, it becomes a fine “talc” like powder. Proper milling cracks apart the diatom's skeleton, exposing microscopic silica needles. These silica needles, sharp and hazardous to insects are harmless to humans and other non-insect animals. The diatomaceous earth powder can be safely handled with bare hands and is regularly fed to animals in small quantities (for internal parasite control). The diatomaceous earth (silica needles) are small and sharp enough to scratch the insect's exoskeleton, which is composed of a hard porous cover protected by an oily or waxy seal. Once the exoskeleton seal is scratched, the insect will most often dehydrate and die.

The typical application of diatomaceous earth is made by dusting the “talc” like powder over the area where insect control is desired. Unfortunately, this dusting application is effective for only a limited duration, as the “talc” like powder is typically washed away by rain or irrigation, and/or sifted beneath larger soil surface debris (i.e. plant debris, mulch, aggregate, loose soil, etc.). Additionally, since the dusted diatomaceous earth is not held securely in place in any way, the effectiveness of the silica needles to scratch the insect's exoskeleton is reduced. Finally it should be noted that diatomaceous earth is also extremely toxic to insects when ingested by them. The silica needles act to shred their gut, virtually tearing them up and drying them out from the inside out.

### SUMMARY OF THE INVENTION

The object of the present invention is to offer consumers a simple non-toxic means for the spot control of crawling insect pests. One embodiment of the invention uses a non-drying, relatively tacky adhesive (like that used for the better grades of fly paper) that is applied to one side of a tape roll. The other side of the tape is coated with a conventional, easily removed contact adhesive (similar to masking tape) that will separate easily and completely when the tape is to be removed. The tape media can be made of paper, vinyl, thin foam, or any other commonly used tape or disposable media. This “two sided” tape with the exposed non-drying (tacky) adhesive has many potential and useful insect control applications. This tape acts more as a barrier than a trap, as insects typically do not get completely stuck to the exposed adhesive, but are able to pull free and simply avoid trying to cross the tape in future encounters. Being configured as an easily removable two sided tape, the insect control application for this product are wide ranging. The insect barrier tape can be used indoors to protect foodstuffs in pantries, food containers, table top surfaces, thresholds or anyplace else that a barrier control for crawling insects is needed. The outdoor use applications range from protecting potted containers, garden and decorative plants to pet food dishes. The convenience of the easily applied and completely removable insect barrier tape allows consumers the freedom to design and experiment with their own insect control applications.

A further refinement of the insect barrier tape uses a combination of a non-drying adhesive with an adjacent or alternating surface with an application of diatomaceous earth. This combination of a tacky non-drying adhesive and diatomaceous earth has the effect of changing the insect barrier tape from an insect deterrent to an insect exterminating product. Insects trying to cross over the exposed tape adhesive will make significant exertions to free themselves from the adhesive and thereby be seriously abraded by the adjacent diatomaceous earth. This physical exertion against the diatomaceous earth acts to amplify or exacerbate the insecticide effect of the diatomaceous earth by greatly increasing the abrasion damage to the insect's exoskeleton.

There are several embodiments of the present invention that take advantage of the “mechanical” non-toxic insect control of diatomaceous earth. These invention embodiments have a significantly improved pest control utility, in that they act to stabilize the “talc” like diatomaceous earth powder thereby prolonging the effectiveness of this relatively passive and “environmentally friendly” insect pest control.

### BRIEF DESCRIPTION OF THE DRAWINGS

FIG. 1 depicts a side view of the non-drying adhesive insect barrier tape;

FIG. 2 depicts a top view of the non-drying adhesive insect barrier tape;

FIG. 3 depicts a side view of the insect barrier tape with embossed reliefs and an additional application of diatomaceous earth;

FIG. 4 depicts a contact sheet with a plurality of lift out insect deterring appliques;

FIG. 5 depicts the exposed, diatomaceous earth exposed side of the insect deterring applique separated from the contact sheet of FIG. 4;

FIG. 6 depicts the contact adhesive coated, back side of the separated insect deterring applique separated from the contact sheet of FIG. 4;

FIG. 7 depicts a contact sheet with a plurality of lift out, faux leaf shaped insect deterring devices;

FIG. 8 depicts a faux leaf shaped insect control device separated from the contact sheet of FIG. 7;

FIG. 9 depicts a separated faux leaf shaped insect control device with integral attachment wire;

FIG. 10 depicts a side view of the non-drying adhesive insect barrier tape with retained low surface contact cover;

FIG. 11 depicts an enlarged view of a free floating, diatomaceous earth laced cellulose based fragment;

FIG. 12 depicts a plurality of the cellulose based fragments of FIG. 11.

### DETAILED DESCRIPTION OF THE INVENTION

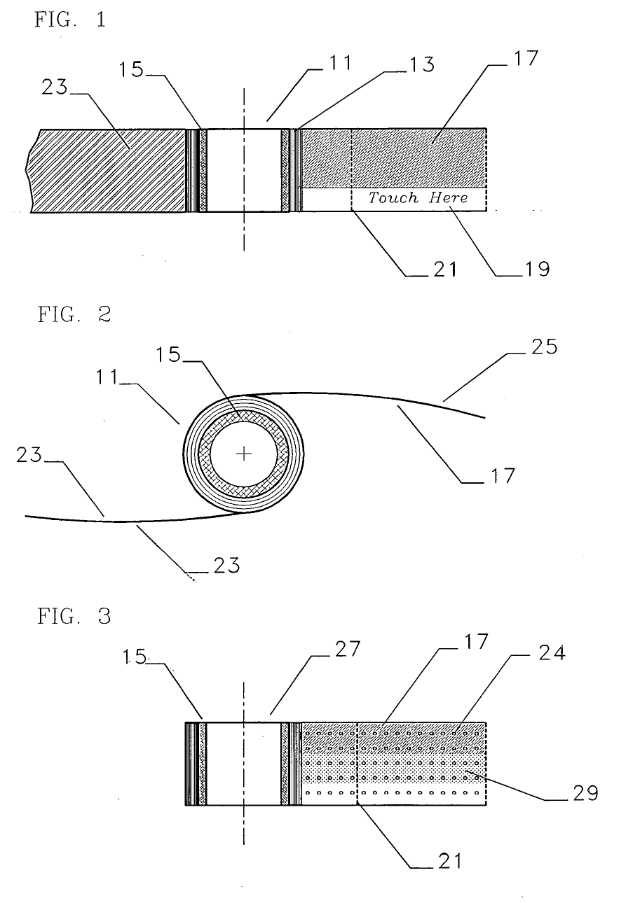

Referring to the FIGS. 1 and 2 there is shown a “two sided” tape 11 with a card paper core 15 and spiral wound tape 13. The tape 13 has an applied non-drying adhesive at 17 and a non-adhesive applied region 19 to allow for easy handling. The tape may be serrated for convenient application as shown in FIG. 1 at 21. The coating 17 is a relatively thick, tacky non-drying adhesive and must be protected from sticking to the reverse side of the tape contact adhesive 25 by the use of a low surface adhesion contact paper as shown at 23. This “two sided” tape 13 may be applied to any surface using the contact or easily removable adhesive side 25. The insect barrier tape may include printed on directions, insect attracting colors (ultraviolet reflecting), or other printed graphics to make the product more appealing and/or easier to use.

The tape surface to which the non-drying adhesives are applied may be made of paper, vinyl, cloth, foam or any number of relatively inexpensive media commonly used for tapes. The tape media will most preferably be waterproof and easily stretched (as with a thin vinyl) for outdoor applications to doorway thresholds, garden boundaries, plant stems, or branches.

FIG. 3 shows a “two sided” tape 27 with an applied non-drying adhesive 17 and a surface application of diatomaceous earth as shown at 29. The combination of the tacky, non-drying adhesive 17 and the surface application of diatomaceous earth 29 is a very effective insect control means. Insects trying to crawl up the tape 27 must pass through the highly abrasive silica needles of the applied diatomaceous earth 29. When these insects touch the non-drying adhesive 17 they will attempt to pull away, thereby exerting physical force against the silica needles that make up the diatomaceous earth 29. The exertion of force to get free from the non-drying adhesive substantially increases the abrading action of the diatomaceous earth, leading to more extensive exo-skeletal damage. The “two sided” tape of FIG. 3 has a contact adhesive on the back side for convenient attachment. The non-drying adhesive 17 and diatomaceous earth 29 may be protected from the contact adhesive on the back of the tape by embossing the tape media with small raised “bumps” as shown at 24. The embossed bumps 24 or the application of other texturing materials will serve to substantially reduce the contact area between the tape front and back coatings. Using embossed bumps 24 or an applied upstanding texture will allow for any of the two sided tapes to be made without the sandwiched layer of low surface adhesion paper. The diatomaceous earth 29 will be fixed to the tape surface using a very thin, drying adhesive coating or applied directly over the tacky, non-drying adhesive. It should be noted that the diatomaceous earth is a non-soluble silica based material that can be applied in any number of conceivable patterns, spots, bars bands over a drying or tacky adhesive layer. An intermixed pattern of non-drying adhesive and diatomaceous earth may be found to be most effective configuration for controlling insects. The “two sided” tape may have only the diatomaceous earth applied to the “outside” surface and it still is an effective if not immediate insect control. It is important that whatever adhesive is used to hold the diatomaceous earth, that it not be applied so thickly as to cover over the insect deterring silica needle structures. The resulting tape surface is similar in structure to a sandpaper, except that the abrasive material is composed of diatomaceous earth. It may be possible to build-up successive layers of the adhesive bound diatomaceous earth in order to extend the effectiveness of the insect controlling tape. The tape surfaces with applied diatomaceous earth may be protected from rubbing on the low surface adhesion contact paper by embossing the tape or contact paper with small bumps or other embossed patterns. The somewhat delicate silica needle structures of the diatomaceous earth may be otherwise be protected from the tape contact adhesive by the application of a pattern of upstanding texturing materials which form reliefs to isolate the adjacent tape surfaces. Either the non-adhesive barrier tape or diatomaceous earth coated tape, or the combination of both, may be made less expensively by using an embossed or applied textured pattern to eliminate the need for a protective covering of low surface adhesion contact paper.

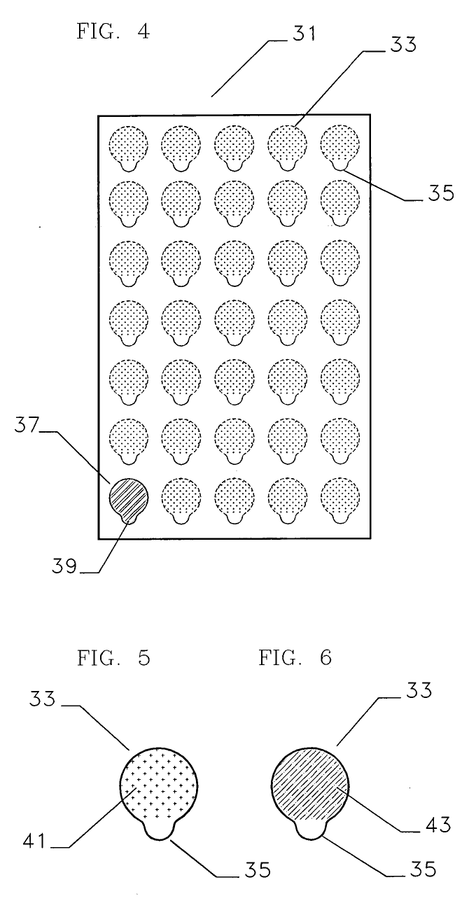

Referring to FIGS. 4-6 there is shown a sheet 31 of diatomaceous earth coated appliques 33 or stickers. These peel-off devices 33 have an applied or encapsulated addition of diatomaceous earth 41 as shown in FIG. 5. The peel-off appliques 33 have an un-coated adhesive handling zone 35 and may have an applied contact adhesive 43 as shown in FIG. 6. These appliques 33 can be separated from the low surface adhesion contact sheet 39 as shown at 37. The appliques 33 can be attached to plant leaves, stems or fruits where insects such as aphids, caterpillars and grasshoppers are most likely to engage in destructive eating. The appliques 33 may be constructed from a very thin paper, cellulose, cellophane, or other plant derived media. The diatomaceous earth is formulated, or encapsulated within the media or intermixed with the applique attaching contact adhesive. The appliques 33 are made thin so that as the leaf edge or stem is consumed by the pest insects a portion of the applique is inadvertently consumed as well. The encapsulated, or diatomaceous earth laced adhesive is exposed during the digestion process and the pest insect's gut will be exposed to severe, shredding type damage. Either the media or contact adhesive (if contact adhesive is used) may be treated with sugar or other attractive baiting substances that make the appliques 33 more palatable to leaf eating insect pests. The use of a contact adhesive 43 may not be required as surface tension alone may be used hold the appliques to a pre-moistened plant leaf, stem or fruit (as a thin decal is typically secured on much of the fruit we buy).

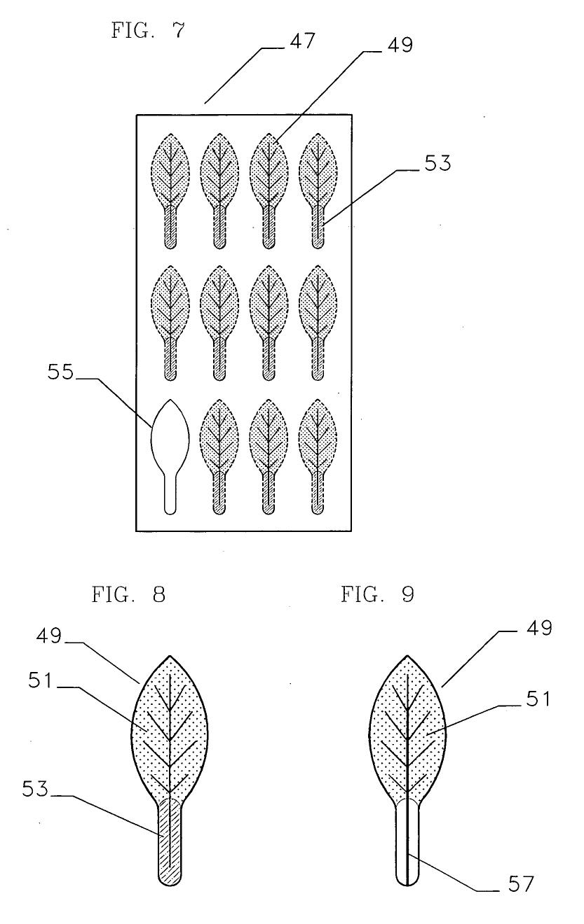

Referring to FIGS. 7-9 there is shown a sheet 47 with a plurality of lift-out leaf shaped insect control devices 49. These faux leafs 49 have an applied layer, encapsulation or formulation of added diatomaceous earth as shown at 51. These leaf shaped devices 49 are made of a cellulose based media and may be treated with sugar or other attractive substances that make them more palatable to leaf eating insect pests. The faux leafs 49 have a self adhesive layer shown at 53 which can be doubled over on itself to attach the leaf 49 to a plant stem, branch or other supporting structure. Alternatively, as shown in FIG. 9, the leafs 49 may be provided with a pliable wire as shown at 57 which can be inserted into the soil, or bent around a plant stem or other supporting structure. The leaf shaped devices 49 may be removed from the contact sheet 47 by pulling the stem tab 53 and lifting them from the sheet as shown at 55. The leaf shaped insect control devices 49 are intended for use as leaf eating insect pest baits. As with the applique devices described earlier, once ingested, the encapsulated or formulated mixture of diatomaceous earth will “score” or shred the gut of the leaf eating insect pest(s) which will result in their extermination.

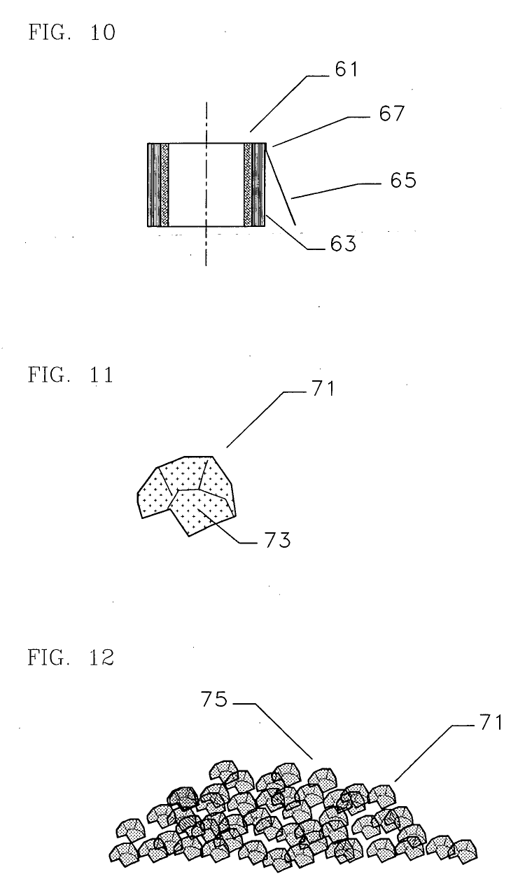

Referring to FIG. 10 there is shown an embodiment of the “two sided” tape 61 where the insect deterring adhesive surface 63 is protected by an attached contact paper 65. The contact paper 65 is permanently attached to the tape at 67. The contact paper 67 forms an integral rain and/or dust cover for the tape and facilitates the handling during the installation and removal of the tape. A tape with this form of protection would be ideal for placing around the perimeter of a pet food dish, food container, plant pot or other items that are more frequently handled.

Finally, referring to FIGS. 11 and 12 there is shown a free floating, cellulose fragment 71. This fragment 71 is a cellulose based insect control device with a formulated additive of diatomaceous earth 73 and a baiting substance such as sugar or other insect attracting substances. The cellulose fragments as shown in FIG. 12 at 75 are intended for random distribution in the garden or other spot areas where insect control is desired. The cellulose fragments 71 may be made using a base of recycled paper, plant debris or other readily available cellulose based materials.

The foregoing description is not intended to be all inclusive of the possible embodiments that the Non-Drying Adhesive Tapes and Diatomaceous Earth Treated Insect Control Devices may have. The devices, once disclosed may be configured in a variety of embodiments that operate similarly to those detailed and described herein. I desire therefore, that my protection be limited, not by the constructions illustrated and described, but only by the proper scope of the appended claims.

I claim:

1. An insect barrier tape for use in spot applications for preventing insect passage, said insect barrier tape including:
a. a disposable tape media, coated on at least one side with a nondrying adhesive layer, said non-drying adhesive layer being sufficiently tacky to act as a physical barrier to the passage of insects; and
b. a surface coating of contact or readily separable adhesive on the said tape media reverse side that allows the tape to be affixed to an exposed surface or structure.

2. The insect barrier tape of claim 1, wherein the tape is constructed of paper, vinyl, foil, foam, Tyvek®, linen, cellophane or any other commonly used tape media.

3. The insect barrier tape of claim 1, wherein the adjacent, front and back, tape adhesive covered surfaces are protected with a covering of low adhesion type contact paper.

4. The insect barrier tape of claim 1, wherein the adjacent, front and back, tape adhesive covered surfaces are protected from excessive contact by an embossed, raised pattern.

5. The insect barrier tape of claim 1, wherein the adjacent, front and back, tape adhesive covered surfaces are protected from excessive contact by an applied pattern of an upstanding textured material.

6. The insect barrier tape of claim 1, wherein said tape has a handling region that is free from the non-drying adhesive coating.

7. The insect barrier tape of claim 1, wherein said tape media has printed-on graphics, symbols and/or directions for use.

8. The insect barrier tape of claim 1, wherein the tape has an additional application of diatomaceous earth.

9. An insect controlling tape for use in spot applications for deterring crawling insects, said insect controlling tape including:
a. a disposable tape media, coated on at least one side with an adhesively bound layer of diatomaceous earth, said diatomaceous earth acting as a physical barrier and insecticide to crawling insects; and
b. a surface coating of contact or readily separable adhesive on the tape media reverse side that allows the tape to be affixed to an exposed surface or structure.

10. The insect controlling tape of claim 9, wherein the tape is constructed of paper, vinyl, foil, foam, Tyvek®, linen, cellophane or any other commonly used tape media.

11. The insect controlling tape of claim 9, wherein the diatomaceous earth covered surface is protected from the tape back side contact adhesive by an embossed, raised pattern.

12. The insect controlling tape of claim 9, wherein the diatomaceous earth covered surface is protected from the tape back side contact adhesive by an applied pattern of an upstanding textured material.

13. The insect controlling tape of claim 9, wherein said tape has a handling region that is free from the diatomaceous earth coating.

14. An insect control device for use in spot applications for killing insects, said insect control device including:
a. a cellulose based media, with a formulated, encapsulated or adhesively bound layer of diatomaceous earth, said diatomaceous earth acting as an insecticide to insects ingesting the media; and
b. said device containing an insect baiting ingredient, such as sugar, that is formulated, encapsulated or adhesively bound with the device to make it more palatable to insect pests.

15. The insect control device of claim 14, wherein the device(s) consist of a plurality of free floating cellulose based fragments.

16. The insect control device of claim 14, wherein the device has a surface coating of contact adhesive that allows the device to be affixed to a plant leaf, stem, fruit or exposed surface or structure.

17. The insect controlling device of claim 14, wherein the device is attached by surface tension to a plant leaf, stem, fruit or exposed surface or structure.

18. The insect controlling device of claim 14, wherein said device has the form and coloration of a faux leaf to make it more attractive to insect pests.

19. The insect controlling device of claim 14, wherein said device has an incorporated pliable wire or other incorporated means to assist in affixing the device to an exposed surface, structure or for securing the device in the soil.

20. The insect controlling device of claim 14, wherein said device has incorporated insect attracting graphic patterns, coloration and/or instructions for use.
